(19) United States
(12) Patent Application Publication
(10) Pub. No.: US 2015/0113143 A1
(43) Pub. Date: Apr. 23, 2015

(54) NETWORK RESOURCE AUTOMATION MANAGEMENT

(71) Applicant: HEWLETT-PACKARD DEVELOPMENT COMPANY, L.P, Houston, TX (US)

(72) Inventors: Leslie R. Stuart, Morgan Hill, CA (US); Ben Collin Van Kerkwyk, Roseville, CA (US); Philippe Michelet, Palo Alto, CA (US)

(73) Assignee: HEWLETT-PACKARD DEVELOPMENT COMPANY, L.P, Houston, TX (US)

(21) Appl. No.: 14/058,013

(22) Filed: Oct. 18, 2013

(51) Int. Cl. H04L 12/911

(52) U.S. Cl. CPC H04L 47/70
USPC 709/226

(57) ABSTRACT

A method for resource automation management includes creating a service model by receiving dragged and dropped abstracted service units into a workspace and receiving connections between the abstracted service units to represent a communication path. The method further includes storing the service model in a computer readable memory and simulating, with a computational processor, the service model in a zone model representing resources and topology in the computer network.

### BACKGROUND

Computer networks are becoming larger and their topology is increasingly complex. Computer networks include both physical and virtual elements that are linked by communication paths. A computer network may simultaneously provide a number of services and support the needs of multiple clients. The configuration of these large computer networks is largely a manual process where one or more computer technicians determines the desired topology and configurations of the elements within the topology and then individually configures the elements to provide the desired functionality. This process is error prone and can result in significant down time of the computer networks. The downtime costs for a computer network can be significant for the network owner, tenants who depend on the network to support their organization and for clients who rely on the services provided by the tenants.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a physically implemented computer network topology, according to one example of principles described herein.

FIG. 2A is a diagram of a graphical user interface for creating a service model, according to one example of principles described herein.

FIG. 2B is a service unit in the service model that has been selected and a configuration popup window is displayed, according to one example of principles described herein.

FIGS. 3A and 3B are charts showing various properties that service units with a service model may have, according to one example of principles described herein.

FIG. 4 is a diagram of a simulation of a service model with a model of a zone within a computer network, according to one example of principles described herein.

FIG. 5 shows results of a simulation of a service model on a model of a zone within a computer network, according to one example of principles described herein.

FIG. 6 is a simulated screen shot of a library of service models, according to one example of principles described herein.

FIG. 7 is a flowchart of a method for resource automation management, according to one example of principles described herein.

FIG. 8 is a flowchart of a more detailed method for resource automation management, according to one example of principles described herein.

FIG. 9 is a diagram of a computer system for implementing resource automation management within a computer network, according to one example of principles described herein.

Throughout the drawings, identical reference numbers designate similar, but not necessarily identical, elements.

### DETAILED DESCRIPTION

Computer networks are becoming larger and their topology is increasingly complex. Configuring computer networks is often a manual process where one or more computer technicians determine the desired topology and configurations of the elements within the topology and then individually configures the elements to form the topology and provide the desired functionality. This process is error prone and can result in significant down time of the computer networks.

The principles described herein enable data center architects to design and create end-to-end virtual slices (“zones”) of data center networking infrastructure. The zones are created by logically slicing the data center into separate, easily understood contexts. Each zone supplies one or more end-to-end virtualized networking services. For example, the zones in the data center can be optimized to “place & route” these virtual zones while providing secure isolation between zones.

A service model made up of abstracted service units is constructed to represent a desired functionality. The service model is tested against a model of a zone and then “compiled” into the actual data center hardware that makes up the zone. Each zone that implements a service model can be optimized using a policy driven approach for specific applications or tenants. The service model can then be used by monitoring applications as a framework to understand and measure the performance of the service delivered, capacity, security, isolation, and overall infrastructure capacity loading.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

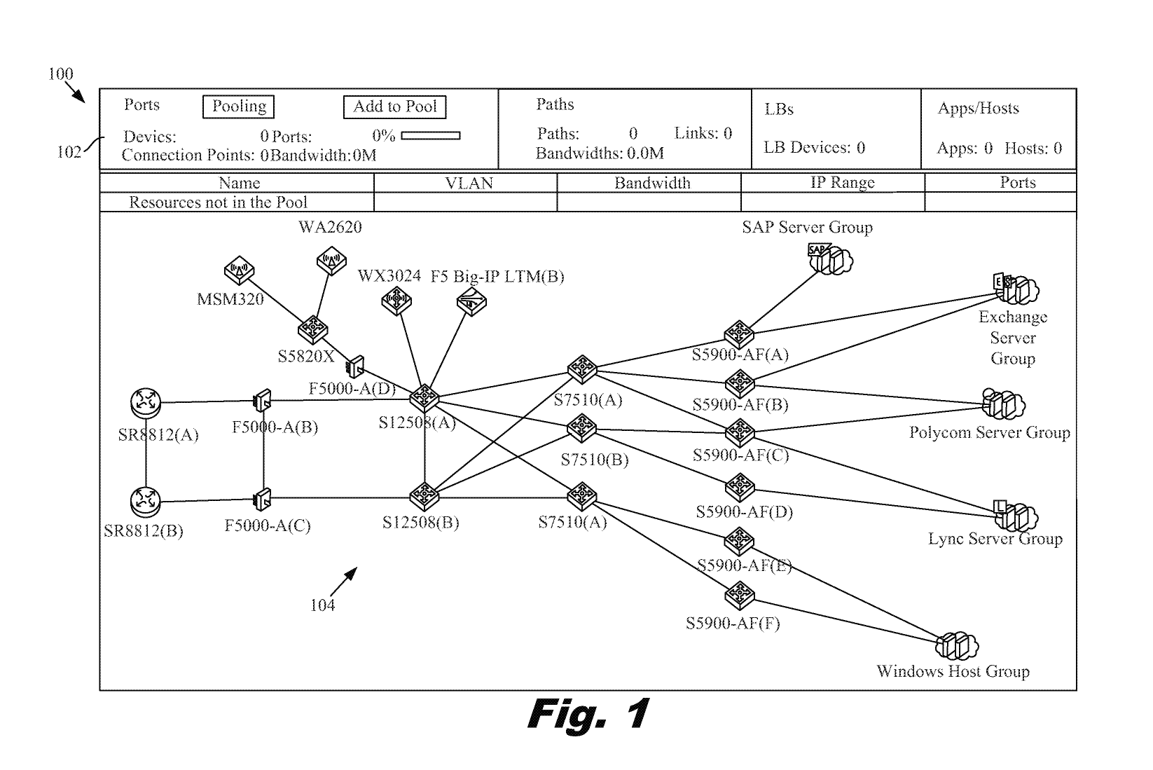

FIG. 1 is a graphical user interface (100) showing a diagram of a physically implemented computer network topology (104). The topology includes a number of elements that graphically represent the physical or virtualized hardware components within the computer network. For example, the elements may include routers/network switches, wireless endpoints, server groups, firewalls, load balancers, access servers, and other elements. Lines between the elements show functional/data connections between the elements.

In this example, a number of server groups are connected to switches that feed routers. The server groups include an SAP server group, an Exchange server group, a Polycom server group, a Lync server group, and a Windows host group. These servers are grouped according to function and illustrated as a single element in the diagram. However, there is no limitation as to how these servers are physically configured or located.

The switches in this example include HP S5900-AF series switches labeled A through F. HP 5900 series switches are high-density, low latency switches that are part of Hewlett Packard's FlexFabric solution. As shown in this example, these servers can be deployed at the server access layer of data centers. The network also includes switches that are labeled as HP S7510, S5820X, S12508 series switches. A wide variety of other suitable switches could be used.

The firewalls include HP F5000 standalone firewalls that provide a throughput of up to 40 gigabits per second and support virtual private networks. Also included are an MSM320 Access Point, a WA2620 Access Point, a WX3024 Wireless switch, a F5 Big-IP Local Traffic Manager (LTM) for load balancing, and SR8812 routers.

The diagram may represent the entire computer network or only a portion of the computer network. The network may be divided into smaller units called zones. A zone can be defined in a number of ways. For example, a zone may be defined by selecting two elements in the network topology. The two elements may be endpoints, servers, or other elements. Anything that directly links and/or is associated with the two endpoints can be included in the zone. For example, an endpoint may be the access router SR8812(A) and the other element may be the Exchange server group. Any elements that are used in the operation of the Exchange server group or interface with the access router could be automatically included in the zone.

These zones provide a logical slice of data center infrastructure per application, which massively simplifies management while improving the quality of service. The various zones can be securely isolated from other zones in the network and can be independently reconfigured. For example, if a service supported within a zone fails, the network administrator has no need to examine the entire network for failures or optimization. Because the failed service is isolated within and provided solely by the zone, only the function zone needs to be examined. Further, the use of zones may facilitate thin provisioning for networks for a just-enough, just-in-time allocation of resources. This can more efficiently utilize the services and resources in layer 4 through layer 7 in the Open Systems Interconnection model. These layers are, sequentially starting with layer 4, the transport layer, the session layer, the presentation layer and the application layer. The topology independent networking with dynamic allocation of network policies described below performs much better than statically configured connectivity and security. For example, the principles described herein enable dynamic placement of workloads and services for greater agility.

In some implementations, the functionality of the network may be pooled into common categories. For example, the pools (102) may include pooling ports, paths/bandwidth, load balancing capacity, applications, hosts, etc. In the example shown in FIG. 1, the pooling of the resources hasn't been performed. After the pooling occurs, the counts will appear in the pools (102).

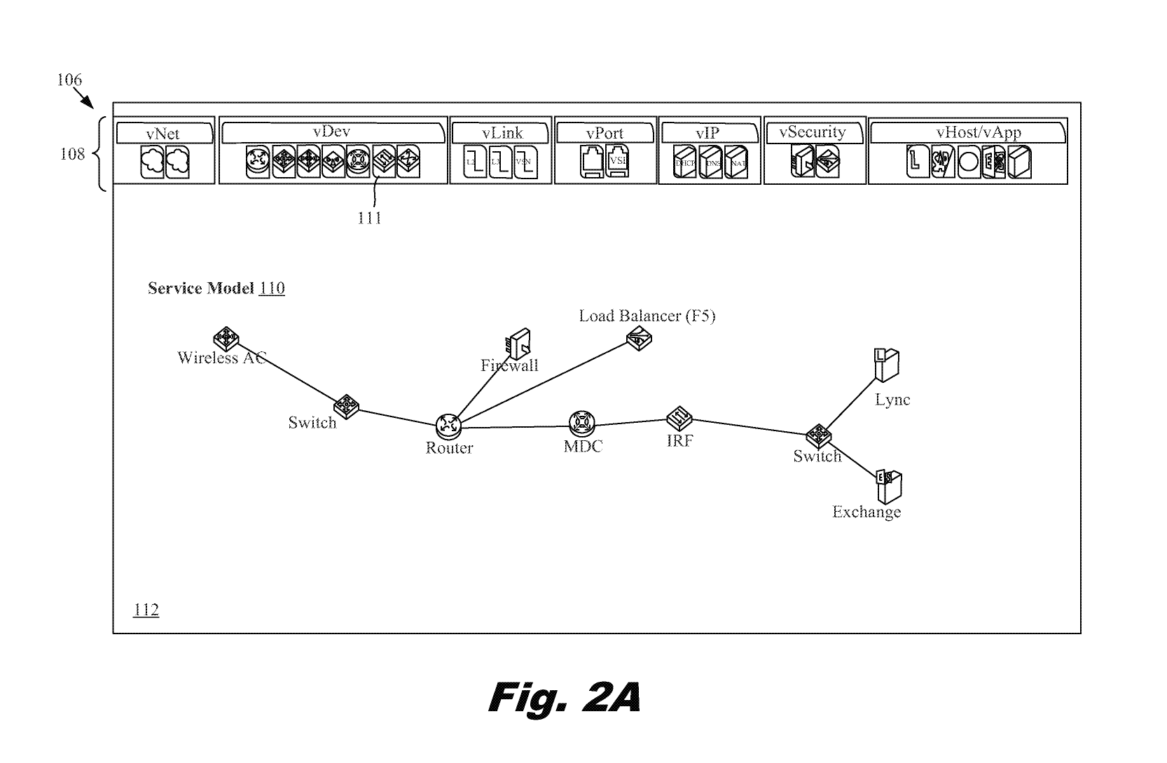

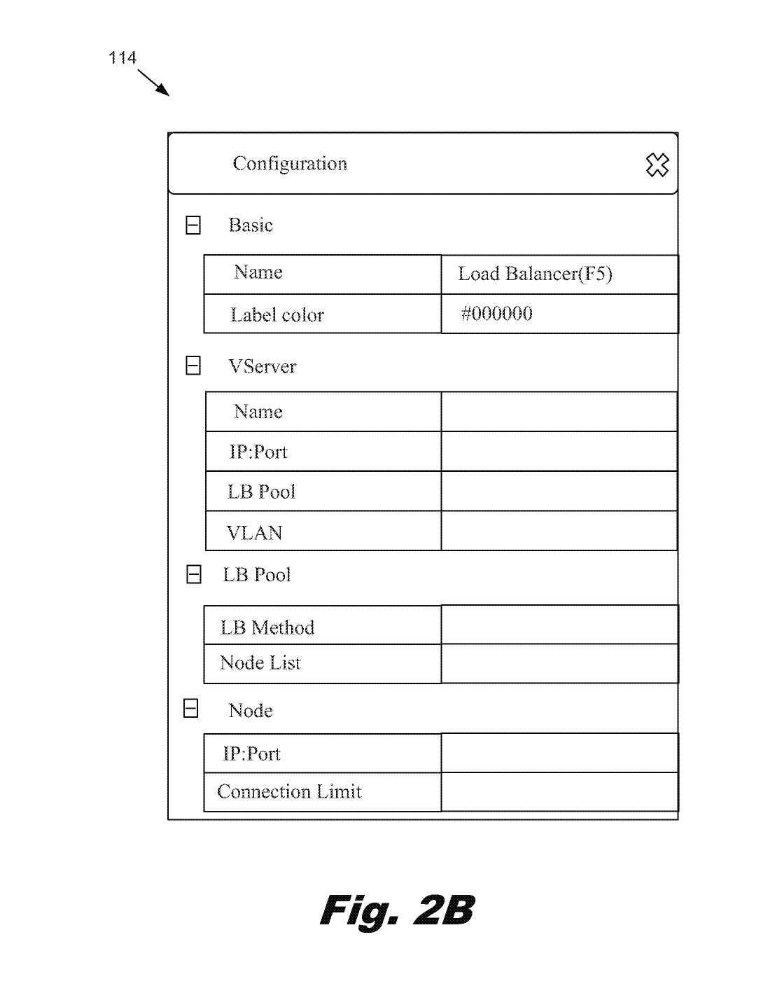

FIG. 2A is a diagram of a graphical user interface (106) for creating a service model (112). The functionality in a computer network has been abstracted into service units (111). In this example, the available types of service units are graphically displayed as icons along the top of the graphical user interface in a tray (108). Each of the service units represent a specific function that may be implemented by computer networking elements, virtual networking elements, software, or combinations thereof.

In this example, the service units are divided into several groups, including a vNet group, a vDev group, a vLink group, vPort group, a vIP group, a vSecure group, and a vHost/vApp group. The vNet group includes Layer 2 (the data link layer) and Layer 3 (the network layer) service units and the vDev group includes (from left to right) a router, a switch, a multi-access endpoint, a wireless endpoint, a Multi-tenant Device Context (MDC), workgroup switch, and an Asynchronous Transfer Mode (ATM) switch.

The vLink group includes service units for L2, L3, and Virtual Private Network (VPN) connections. The vPort group includes a physical port and a Virtual Switch Instance (VSI) port. The vIP group includes a Dynamic Host Configuration Protocol (DHCP), Domain Name System (DNS) unit, and a Network Address Translation (NAT) unit. The vSecurity group includes a firewall unit and a load balancing unit. The vHost group could include a variety of applications and other service units. The description of service units above is only one example. A number of different service units could be included. New service units may be created by defining their properties and including them in a service unit library.

Each service unit can be selected, for example, by clicking on the icon representing the service unit, and dragging the selected service unit into the desired location in the model workspace. Forming connections between the new service unit and the other units joins the new service unit to the service model. In this example, the service model includes a Lync server and an Exchange server connected to a switch. This connection is then routed through several software/virtual elements, including an Intelligent Resilient Framework (IRF, a software virtualization technology for routing configuration and management), and a MDC. The connection is then made to a router which is also connected to a firewall and a load balancer. A wireless access point is connected to the router through a switch. This configuration supplies users connected to the wireless access point with services provided by the Lync and Exchange servers.

The service units may be created by defining its properties and included in the service unit library. In FIG. 2B, a service unit in the service model has been selected and a configuration popup window (114) has been displayed. In this example, the F5 load balancer has been selected. The properties of the load balancer include its name, label color and various technical specifications such as its server, pool, and node characteristics.

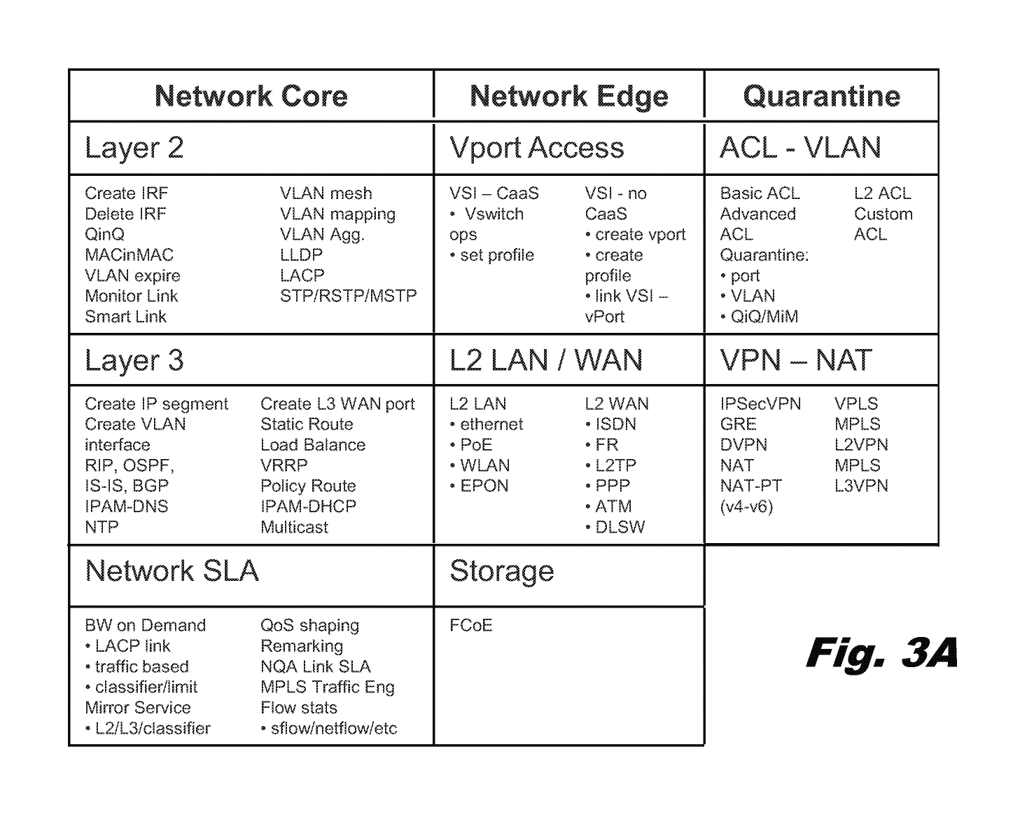

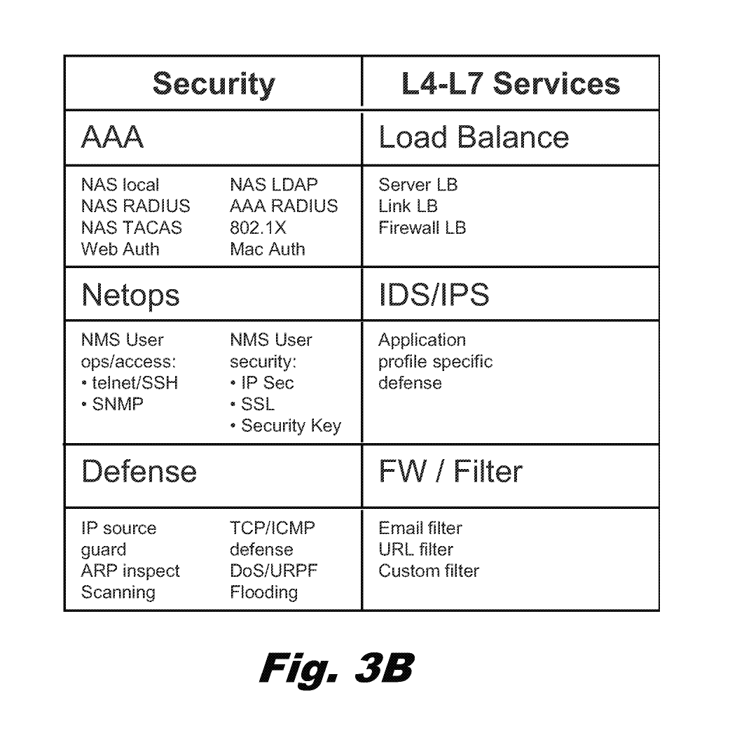

There are a wide range of properties for the service units that can be defined. FIGS. 3A and 3B are charts showing a few examples of properties for service units. The charts in FIGS. 3A and 3B list only the title of the property. The individual service units may not include all of the properties listed, but will include only properties that are relevant to the specific unit. Each property can be further defined by a more technical description that allows: further inspection of the property by an operator; defines its compatibility and interfaces with other units/systems; and, in some instances, allows the service unit to be automatically implemented in virtual or physical hardware.

In FIGS. 3A and 3B, the properties of the service units are categorized according to their location in the network (core, edge, L4-L7 services) or according to function (security, quarantine). For example, in FIG. 3B, a load balance service unit is categorized under L4-L7 services and includes a server load balancing (Server LB), link load balancing (Link LB), and firewall load balancing (Firewall LB) properties.

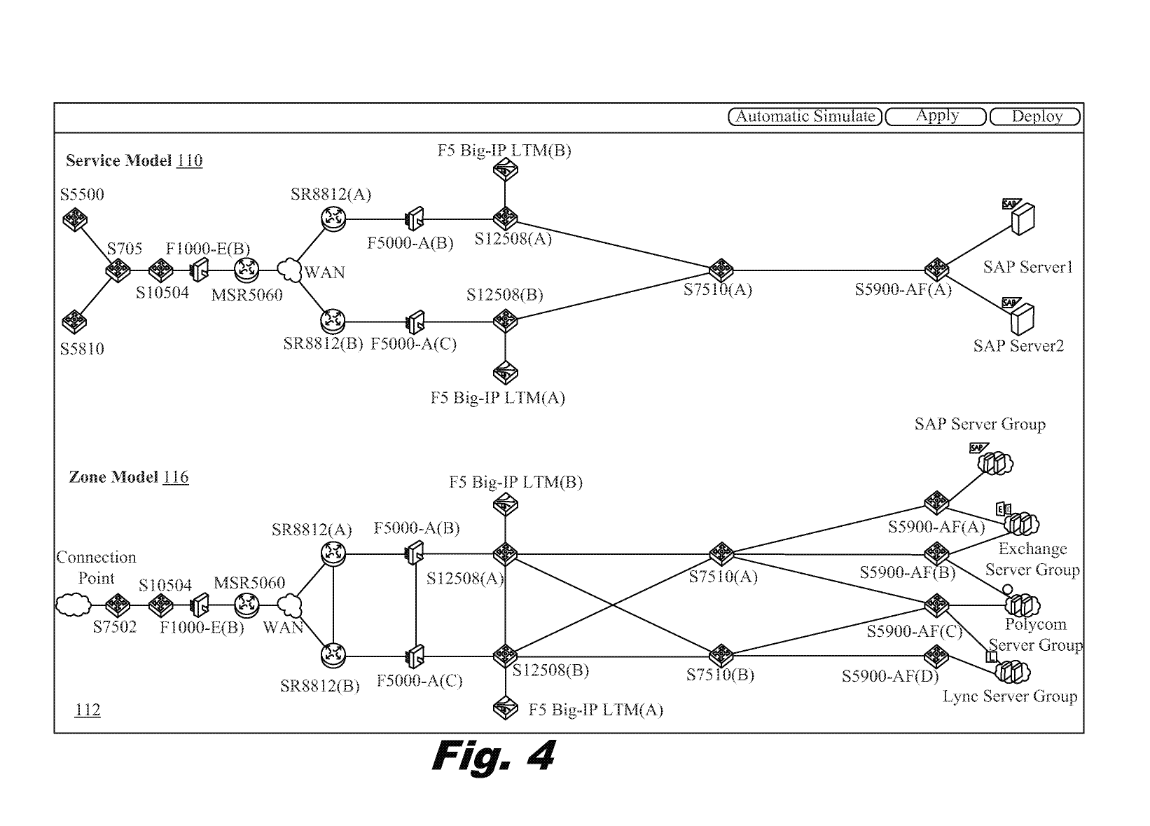

FIG. 4 is a diagram of a service model (110) in the upper portion of the workspace (112) and a zone model (116) within a computer network in the lower portion of the workspace (112). As discussed above, the service model (110) includes virtualized service units that are designed to define a service or tenant requirement that is to be implemented on the computer network system. In FIG. 4, the service model (110) shows two SAP application servers that are configured to deliver services through a number of routers and switches to service units S5500 and S5810. Firewalls are appropriately located throughout the model to control undesired traffic. Load balancing is provided by two F-5 Traffic Managers. The properties of each of the service units may be accessed in a variety of ways, including directly clicking on the service unit or by clicking on a balloon near the service unit. This will bring up a listing of the properties of the service unit. In some examples, these properties are predefined but can be altered if desired.

The zone model (116) is created from the inventory of the computer network system. The system transfers/simulates the service model (110) within the zone model. This simulation can be performed in a variety of ways. For example, each service unit may be individually transferred to the zone model and any errors or incompatibilities between the service unit and the model can be identified. For example, a switch service unit may have a property of supporting VLAN operation, which may not be available on a load balancer service unit in the model of the zone.

Additionally, once the transfer of the individual service units is accomplished and any errors are resolved, the entire service model (110) could be simulated. This would show the performance of the overall service model within the zone model so that system parameters such as latency and data volumes could be determined.

In the interface, there are several buttons on the upper right hand corner. These buttons are “automatically simulate,” “apply,” and “deploy.” By clicking the automatic simulate button, the individual service units are transferred to the zone model (116) and checked. For example, after the automatic simulate button is pressed, each individual service unit may be separately shown as moving from the service model (110) into the zone model (116). If there are any issues or incompatibilities detected, these errors can be shown graphically in any of a number of ways. For example, the service unit icon may change to a red color, flash, or the display a flag indicating the error.

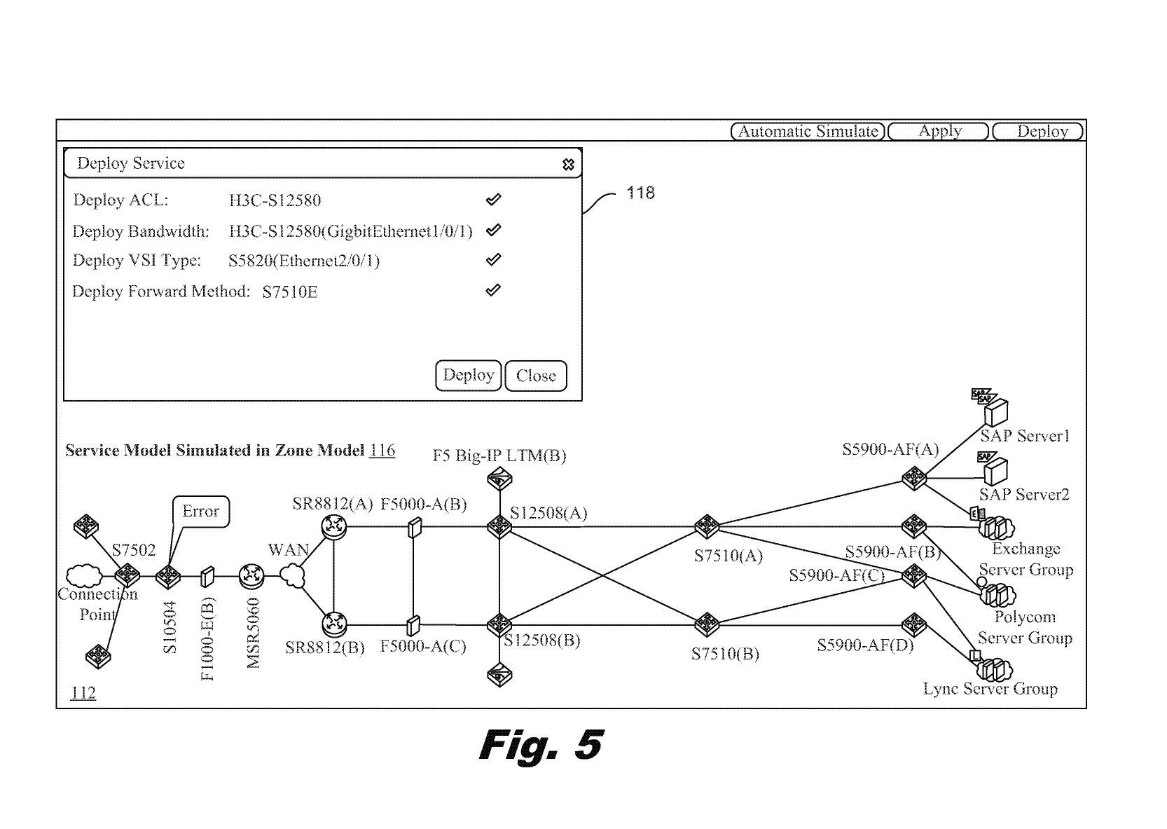

An illustrative simulation (117) of the service model in the zone model is shown in FIG. 5. After transferring each of the individual service units to the zone model, the service model (110, FIG. 4) is no longer shown in the upper portion of the workspace (112). There has been at least one issue noted during the transfer of the service model (110, FIG. 4) to the zone model (116). Specifically, the switch S10504 has an error balloon indicating that one of the properties of the service unit that it is supporting is not compatible with its hardware configuration. For example, the switch may be configured with certain VLANs, while the service unit that is supported by the switch calls for VLANs that conflict with those configured on the switch. This problem can be resolved in a number of ways, including changing the service unit properties to use an alternative technology supported by the physical hardware, changing the definition of the zone to include compatible hardware, redesigning the service model, or other techniques.

After the service model checks out in the zone model, the deploy button can be selected in the upper right hand corner of the screen to actually deploy the service model in the computer network system. The popup screen (118) shows various aspects of the deployment with check marks indicating successful implementation. The deployment may be completely automated or partially automated. For example, the deployment may include transfer or implementation of properties of the various service units to the physical or virtual elements within the computer network. The deployment may utilize a number of techniques, including optimization of the deployment sequence.

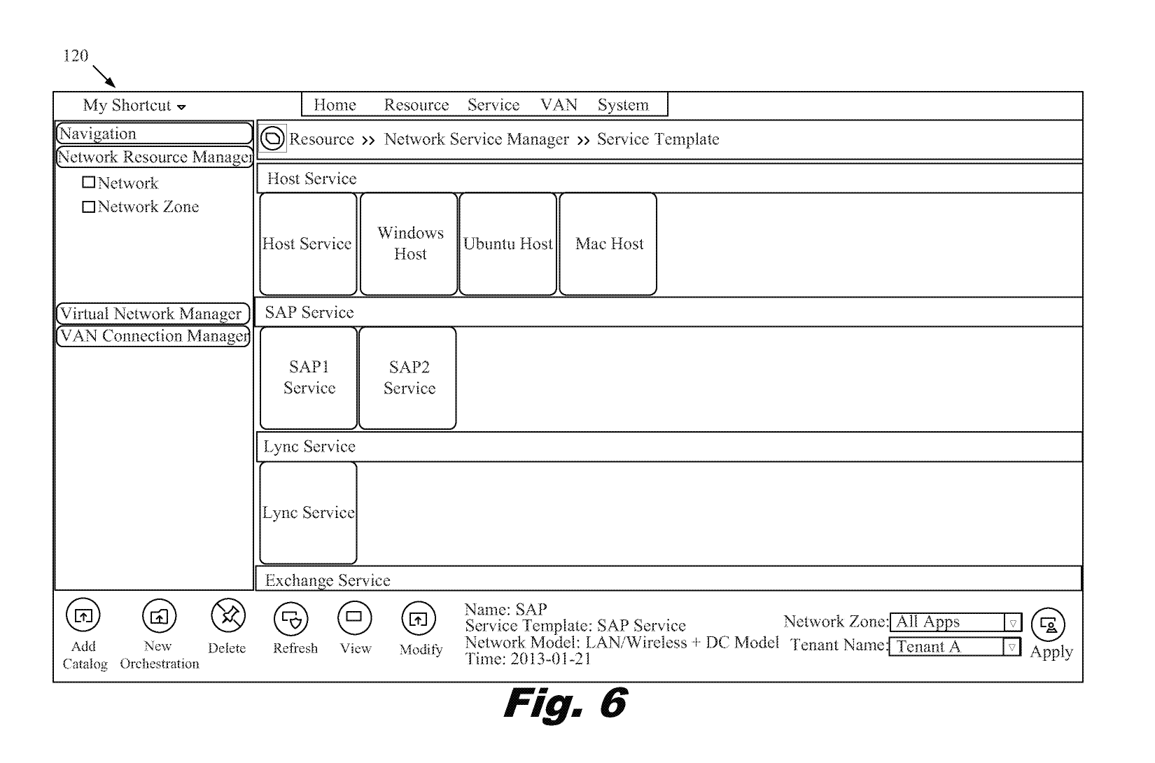

The various service models can be saved and stored for later use in a catalog as shown in FIG. 6. FIG. 6 shows a simulated screen shot of a library of service models. It may be particularly valuable to store service models that have been validated and implemented so that they can be reused. For example, a Microsoft Exchange Server® model may be generated and implemented to support a tenant's East Coast operations. Later, the same model could be used to implement the tenant's Exchange Server for the tenant's West Coast operations. In this example, the catalog includes several categories including “Host Service,” “SAP Service” and “Lync Service.” Each of the categories may store one or more service models. For example, the Host Service category includes a “Host Service” model, a “Windows Host” model, an “Ubuntu Host” model and a “Mac Host” model. Where the computer system hosts multiple tenants, a service model library may be specifically generated for each tenant or a common library may be used.

Generating a model for a service and then simulating the service on a model of the target network provides a number of advantages. For example, a wide variety of “what if” scenarios can be run on the model of the network. This allows for experimentation and optimization of the services and hardware to be deployed without disrupting the operation of the network. Additionally, because each service model is validated through the simulation process, the actual deployment of the service model will have fewer conflicts and deployment errors. By saving various service models in library, the accumulated knowledge generated by the network administrators can be effectively captured and reutilized. Additionally, the service models saved in the library can be further optimized and redeployed in a variety of different networks and situations.

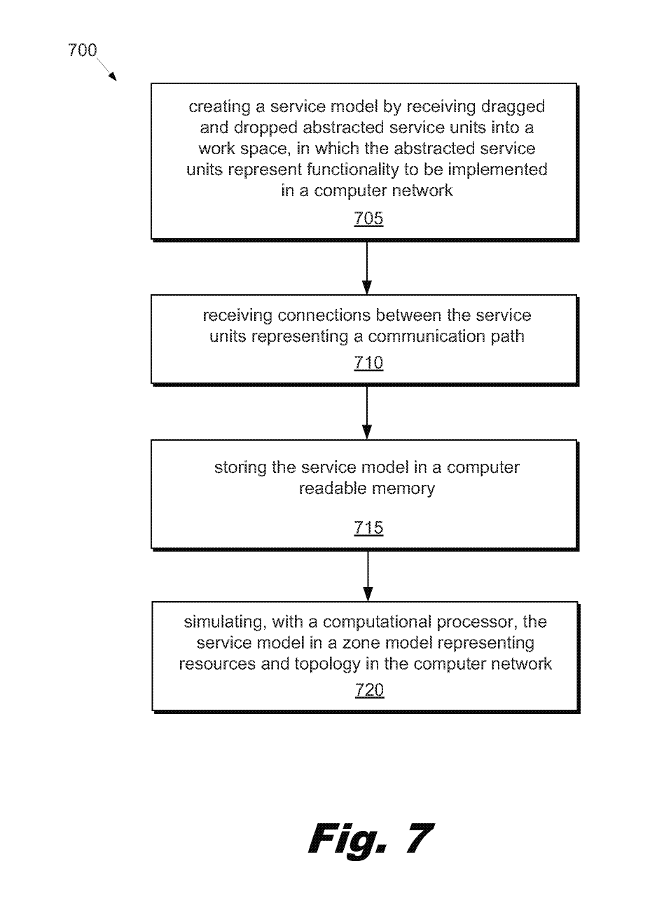

FIG. 7 is a flowchart of a method (700) for resource automation management that includes creating a service model by receiving dragged and dropped abstracted service units into a workspace. As discussed above, the abstracted service units represent functionality to be implemented in a computer network (block 705). These service units may be selected from a task bar and dragged and dropped into a workspace. Connections between the service units are connected with a line representing a communication path (block 710). The service model is stored in a computer readable memory (block 715). The service model is then simulated using a computational processor in a zone model representing resources and topology in the computer network (block 720).

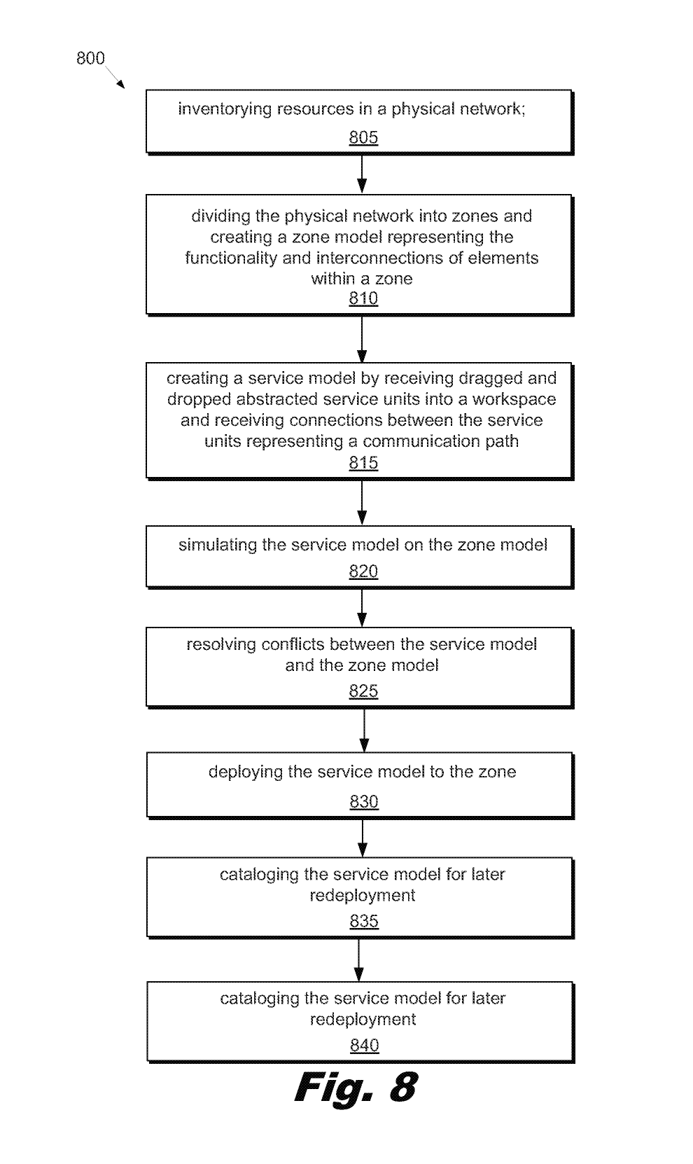

FIG. 8 is a flowchart of a more detailed method (800) for resource automation management. In this implementation, the resources are inventoried in a computer network (block 805). The computer network is then divided into zones and a zone model is created to represent the functionality and interconnections of elements within a zone (block 810). A service model is created by receiving dragged and dropped abstracted service units into a workspace and receiving connections between the service units representing a communication path (block 815). The service model is then simulated within the zone model (block 820). Conflicts, if any, are resolved between the service model and the zone model (block 825). For example, each of the service units may be separately applied to the zone model and errors/conflicts between the service unit and the zone model can be identified. These errors can be resolved prior to simulating the entire service model in the zone model.

The service model is then deployed to the zone represented by the zone model (block 830). The service model can then be cataloged for later redeployment and/or optimization (block 835). The service model can then be used in a monitoring application to monitor the quality of service parameters in the zone (block 840). For example, these quality of service parameters may include bandwidth, latency, latency jitter, and data loss.

The methods given above are only examples. The principles described could be implemented in a variety of different ways, including adding blocks, combining blocks, reordering blocks, or removing blocks.

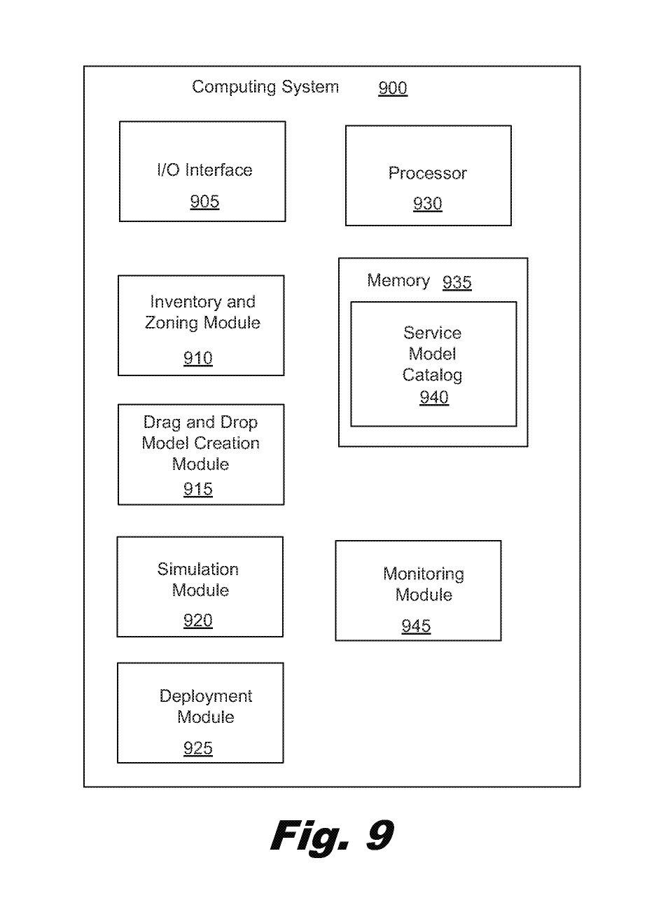

FIG. 9 is a diagram of a computer system (900) for implementing resource automation management within a computer network. The computing system (900) could be a single computer or a system of network computers. The computing system includes an input/output interface (905), a processor (930), and memory (935). The processor executes computer readable program code to implement the various modules and functionalities in the system, including an inventory and zoning module (910). The inventory and zoning module conducts or receives the inventory of the computer network system. The inventory includes identification of each of the elements in the computing system, the characteristics of each element and interconnectivity between the elements. The inventory produces topography of the computer network which is then divided into zones. In general, a zone may include all or less than all of the elements in the computer network. Typically zones are defined to include a specific functionality or section of the network. The zones can be modeled as a logical representation of an end-to-end slice of a computer network where the end-to-end slice includes all the functionality to support delivery of a service.

The computing system also includes a drag and drop model creation module (915) for creation of a service model. As discussed above, the drag and drop creation module may include a number of service units represented as icons. By dragging and dropping the service units into a working area and then connecting the various service units, a service model is created to perform the desired function. The drag and drop model creation module (915) receives service units that are dragged and dropped into the workspace and connections that are made between the units. A simulation module (920) validates the service model within the selected zone model and notes any errors, incompatibilities or other issues. These errors can be graphically displayed in the graphical user interface. After resolving any issues that prevent deployment, the service model can be deployed on the computer network by the deployment module (925) to reconfigure the network and allow the desired functionality to be implemented. In one embodiment, all of the modules described above are implemented by the same application.

After successful implementation, the service model can be stored in a service model catalog (940) stored in memory (935). The service model can be feed into a monitoring module (945) to define the topography of the service being provided. The service module may also define various quality of service parameters. Use of the service module by the monitoring module allows the monitoring module to automatically monitor quality of service without manual configuration by an operator.

The resource automation management principles described above provide management tools to discover and display data center resources; drag and drop these resources into a zone; define the access policies; and then compile the set of commands that are needed to manage each zone separately. This avoids the state of the art manual methods that are time consuming, difficult to modify, and error prone.

The principles described herein may be embodied as a system, method or computer program product. The principles may take the form of an entirely hardware implementation, an implementation combining software and hardware aspects, or an implementation that includes a computer program product that includes one or more computer readable storage medium(s) having computer readable program code embodied thereon. Any combination of one or more computer readable storage medium(s) may be utilized. Examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Computer program code for carrying out operations according to the principles described herein may be written in any suitable programming language. Program code embodied on a computer readable medium may be transmitted using any appropriate medium, including but not limited to wireless, wireline, optical fiber cable, RF, etc., or any suitable combination of the foregoing.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for resource automation management comprising:
creating a service model by:
receiving dragged and dropped abstracted service units into a workspace, in which the abstracted service units represent functionality to be implemented in a computer network; and
receiving connections between the abstracted service units representing a communication path;
storing the service model in a computer readable memory; and
simulating, with a computational processor, the service model in a zone model representing resources and topology in the computer network.

2. The method of claim 1, further comprising resolving conflicts between the service model and the zone model.

3. The method of claim 1, further comprising:
inventorying resources in the computer network; and
dividing the computer network into zones and creating the zone model representing the functionality and interconnections of elements within a zone.

4. The method of claim 3, further comprising deploying the service model to a zone represented by the zone model.

5. The method of claim 4, in which deploying the service model to the zone comprises automatic reconfiguration of elements within the zone to implement properties of the abstracted service units in the service model.

6. The method of claim 1, further comprising cataloging the service model for later redeployment.

7. The method of claim 1, further comprising using the service model in a monitoring application to monitor quality of service parameters in a zone of the computer network represented by the zone model.

8. The method of claim 7, in which the zone comprises an end-to-end slice of the computer network configured to execute and deliver a service.

9. The method of claim 7, in which the zone is securely isolated from other zones in the computer network and can be independently reconfigured.

10. The method of claim 1, further comprising:
separately applying each of the abstracted service units to the zone model;
determining an error when applying the abstracted service units to the zone model; and
resolving the error prior to simulating the service model.

11. A method for resource automation management comprising:
inventorying resources in a computer network;
dividing the computer network into zones and creating a zone model representing functionality and interconnections of elements within a zone;
creating a service model by receiving dragged and dropped abstracted service units into a workspace and receiving connections between the abstracted service units representing a communication path, in which the service model is stored in computer readable memory;
simulating, with a computational processor, the service model on the zone model;
resolving conflicts between the service model and the zone model;
deploying the service model to the zone;
cataloging the service model for later redeployment; and
using the service model in a monitoring application to monitor quality of service parameters in the zone.

12. The method of claim 11, further comprising creating new abstracted service units by:
defining properties of a function;
assigning an icon to represent the properties; and
placing the icon in a tray accessible to a user for dragging and dropping into the workspace.

13. The method of claim 11, in which resolving conflicts between the service model and the zone model comprises at least one of:
changing properties of the abstracted service unit to use an alternative technology supported by physical hardware within the zone;
changing a definition of the zone to include compatible hardware in the computer network; or
redesigning the service model.

14. A system for resource automation management comprising:
a graphical user interface;
a plurality of service units each comprising:
an icon displayed on the graphical user interface; and
a plurality of properties defining a function of the service units; in which icons for the service units are displayed in a tray in the graphical user interface;
a workspace to receive the icons of service units dragged from the tray and dropped into the workspace; and
connections between the service units to form a service model displayed in the workspace.

15. The system of claim 14, further comprising a zone model, in which the zone model comprises a logical representation of an end-to-end slice of a computer network, in which the end-to-end slice includes all the functionality to support delivery of a service.

16. The system of claim 15, further comprising a simulation module to simulate the service model in the zone model and graphically display errors in the graphical user interface.

17. The system of claim 15, further comprising a deployment module to deploy the service model in the end-to-end slice of the computer network.

18. The system of claim 17, further comprising a service model catalog to store the service model for retrieval.

19. The system of claim 15, further comprising a monitoring module to monitor performance of the service model as implemented on the end-to-end slice of the computer network, in which the monitoring module comprises a quality of service application to use the service model to identify components and parameters to monitor within the computer network.

20. The system of claim 14, further comprising an inventory and zoning module to inventory a computer network and define a end-to-end slices of the computer network to form zones within the computer network, in which an inventory and zoning module is to accept an endpoint selection from a user and an element selection from the user and define a zone based on a first endpoint and a second element.
